(19) United States
(12) Patent Application Publication
(10) Pub. No.: US 2009/0193343 A1
(43) Pub. Date: Jul. 30, 2009

(54) METHOD FOR AVOIDING VIRTUAL WORLD FATIGUE BY MAINTAINING AVATAR CHARACTERISTICS IN AN AVATAR WALLET

(75) Inventors: Daniel H. Jones, Round Rock, TX (US); Thomas G. Lendacky, Austin, TX (US); Emily J. Ratliff, Austin, TX (US); George C. Wilson, Austin, TX (US)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/018,951

(22) Filed: Jan. 24, 2008

(51) Int. Cl. G06F 3/00

(52) U.S. Cl. 715/753

(57) ABSTRACT

A method of avoiding virtual world fatigue by generating an active avatar in an avatar wallet. The method includes creating and storing an active avatar in the avatar wallet, selecting target worlds for the active avatar to visit, modifying the initial appearance, the user information, the contact map and the characteristic sharing information of the active avatar in accordance with user preferences with respect to each of the target worlds so as to generate a version of the active avatar for each of the target worlds, and initiating a submission of a version of the active avatar to the corresponding target world such that the version is automatically tailored to allowable avatar properties of the corresponding target world.

### BACKGROUND OF THE INVENTION

1. Field of the Invention

Aspects of the present invention relate to a method of avoiding virtual world fatigue and, more particularly, to a method of avoiding virtual world fatigue by maintaining avatar characteristics in an avatar wallet.

2. Description of the Background

A social network service is a service that focuses on the building and verifying of online social networks for communities of people who share interests and activities, or who are interested in exploring the interests and activities of others, and which necessitates the use of software. Most social network services are primarily web based and provide a collection of various ways for users to interact, such as chat, messaging, email, video, voice chat, file sharing, blogging, discussion groups, etc. The main types of social networking services are those that contain directories of some categories (such as former classmates), means to connect with friends (usually with self-description pages), recommendation systems and/or combinations thereof.

Recently, however, there have been discussions of a phenomenon known as “social networking fatigue,” which refers generally to the exhaustion that individuals within the social network feel when forced to enter their data on each new social networking site they wish to join due to a perception of the new social networking site as being “hot.” This fatigue is now spreading to virtual worlds where users are becoming tired of having to create avatars for themselves over and over again on each new world that they and their friends decide to congregate in.

### SUMMARY OF THE INVENTION

In accordance with an embodiment of the invention, a method of avoiding virtual world fatigue by generating an active avatar in an avatar wallet is provided and includes creating a new avatar, initially editing an existing avatar or initially editing an imported avatar in the avatar wallet so as to generate the active avatar with an initial appearance, user information, a contact map and characteristic sharing information, storing the active avatar in the avatar wallet, selecting target worlds for the active avatar to visit, modifying the initial appearance, the user information, the contact map and the characteristic sharing information of the active avatar in accordance with user preferences with respect to each of the target worlds so as to generate a version of the active avatar for each of the target worlds, and initiating a submission of a version of the active avatar to the corresponding target world such that the version is automatically tailored to allowable avatar properties of the corresponding target world, the automatic tailoring of the version comprising comparing the version with the allowable avatar properties of the corresponding target world, and editing the version in accordance with a result of the comparison so as to generate a final version of the active avatar for the corresponding target world.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTIONS OF THE DRAWINGS

The subject matter regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 is a schematic drawing of an exemplary apparatus including an avatar wallet in accordance with an embodiment of the invention; and

FIG. 2 is a flow diagram of an exemplary method of avoiding virtual world fatigue by maintaining avatar characteristics in an avatar wallet in accordance with an embodiment of the invention.

### DETAILED DESCRIPTION OF THE INVENTION

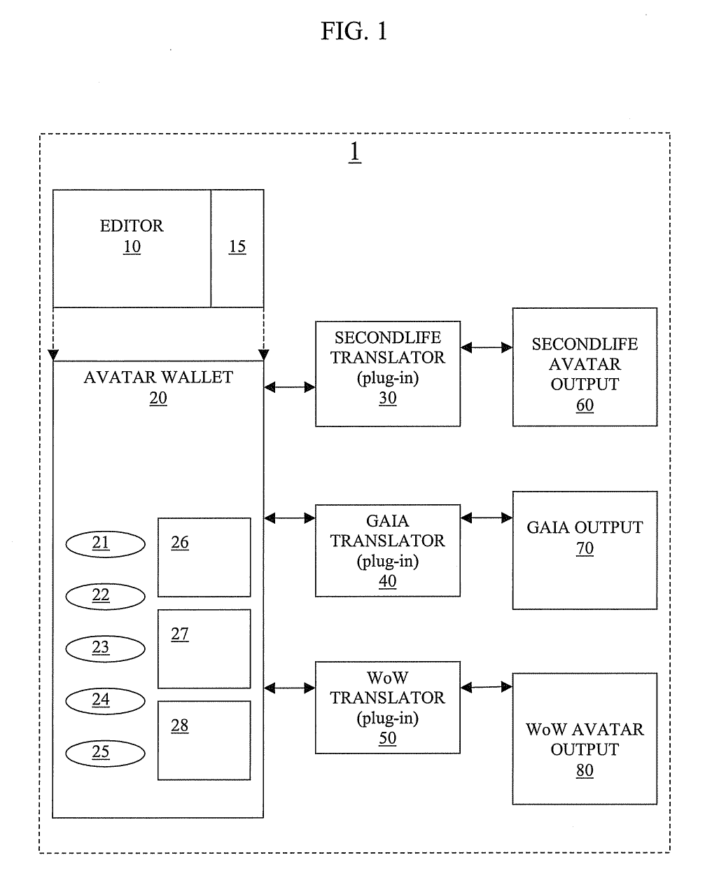

With reference to FIG. 1, an apparatus 1, such as a personal computer for use by a user, includes an editor 10 that drives an avatar wallet 20. The avatar wallet 20 allows a user to create a new avatar, initially edit an already existing avatar and/or initially edit an imported avatar that is generated by, stored in and/or imported into a storage unit 15 of the editor 10 or the avatar wallet 20. The avatar, once created or edited, may be submitted by the user to various virtual target worlds so as to “visit” those target worlds.

Thus, in accordance with an embodiment of the invention, once the user creates an avatar in the avatar wallet 20, the avatar can be stored and submitted to any target world that the user wishes to visit with generally only minor changes. In accordance with other embodiments of the invention, since some target worlds allow for a complete specification of the user's avatars while others are very restrictive (e.g., the WoW virtual world allows for a limited number of various avatars that the user must choose from), the avatar may be designed with regard to the most avatar restrictive target world. In this case, the need for required subsequent avatar modifications may be mimmized.

The avatar wallet 20 includes an avatar editor, including a plurality of buttons 21, 22, 23, 24 and 25, which allow the user to design the avatar as he/she wants by allowing the user to modify a set of appearance attributes, such as eye color, hair color and face shape. The avatar wallet 20 further includes a user properties unit 26, which allows the user to attach information about him/herself to the avatar, a contact mapping unit 27, which allows the user to map the user's contacts and to attach the mapping to the avatar, and a security/configuration unit 28, which allows the user to set a security level for each of the target worlds.

Thus, the user may create a single avatar that visits each of the target worlds or a set of versions of the avatar specifically designed for submission to each target world. Where the user wishes to create the versions of the avatar, the user may modify the initial appearance of the avatar for a corresponding target world. The user may also change the information and the contact map associated with the avatar for the corresponding target world. Finally, the user may modify the characteristic sharing information of the avatar in accordance with the user's preferences with respect to the corresponding target world. That is, while a user may wish to visit “SecondLife” and “WoW,” he/she may only want to allow the “SecondLife” virtual world to have access to his/her credit card. In this case, the user may specify a higher level of security to be associated with his avatar when visiting “WoW” than when visiting “SecondLife.”

Once the user completes the active avatar generation and once the user has selected the target worlds to be visited, a version of the avatar for each target world is outputted from the editor 10 and a submission of the version to the target worlds is initiated. The submission involves engaging translators 30, 40 and 50 of the avatar wallet 20, of which one corresponds to the target world. In this capacity, the translators 30, 40 and 50 may each comprise a plug-in that is associated with its corresponding target world. As such, each translator 30, 40 and 50 is configured to automatically tailor the avatar for any social networking site or virtual world that the user wishes to join.

In detail, when a submission of a version of an active avatar to a corresponding target world is initiated, the version is automatically tailored to allowable avatar properties of the corresponding target world. The automatic tailoring of the version includes comparing the version with the allowable avatar properties of the corresponding target world, and editing the version in accordance with a result of the comparison so as to generate a final version of the active avatar for the corresponding target world. For example, if the user wishes to join virtual worlds “SecondLife,” “Gaia,” and “WoW,” the translators 30, 40 and 50 will be respectively configured to automatically tailor versions of the active avatar to their corresponding virtual worlds and to generate a set of appropriate outputs 60, 70 and 80 as a result.

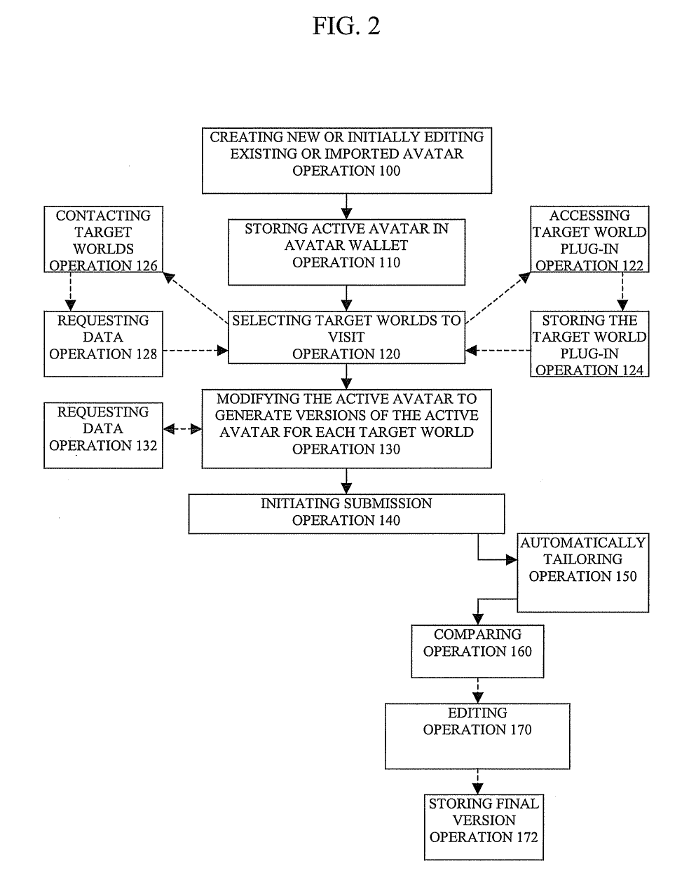

To this end, with respect to FIG. 2, a method of avoiding virtual world fatigue by generating an active avatar in an avatar wallet is provided. In accordance with an embodiment, the method initially includes creating a new avatar, initially editing an existing avatar or initially editing an imported avatar in the avatar wallet so as to generate the active avatar with an initial appearance, user information, a contact map and characteristic sharing information (operation 100) and storing the active avatar in the avatar wallet (operation 110). Thus, a user employing the method may generate his/her active avatar to have a variable appearance and may also embed additional information about him/herself in the active avatar, such as real-world friends and credit card information.

At this point, the user selects target worlds for the active avatar to visit (operation 120). Here, the selecting of the target worlds may include accessing a target world plug-in for each of the selected target worlds (operation 122), and storing the target world plug-in in the avatar wallet (operation 124). The selecting of the target worlds may further include contacting each of the target worlds (operation 126), and requesting data describing the allowable avatar properties of each of the target worlds (operation 128).

The user then modifies the initial appearance, the user information, the contact map and the characteristic sharing information of the active avatar in accordance with user preferences with respect to each of the target worlds so as to generate a version of the active avatar for each of the target worlds (operation 130). Here, the modifying may include both appearance modifications and, e.g., customized security clearances, in which different data is allowed to be transmitted to various target worlds (operation 132). For example, a user who selects “SecondLife” and “Gaia” may want his/her “SecondLife” avatar to a have a particular appearance and may be willing to give his/her credit card information to the administrator of “SecondLife.” However, the user may prefer that his/her avatar look different in “Gaia” and may not want to allow the administrator of “Gaia” to have the same level of access to his/her credit card information.

Lastly, the user initiates a submission of a version of the active avatar to the corresponding target world (operation 140) such that the version is automatically tailored to allowable avatar properties of the corresponding target world (operation 150). Here, the automatic tailoring of the version includes comparing the version with the allowable avatar properties of the corresponding target world (operation 160), and editing the version in accordance with a result of the comparison so as to generate a final version of the active avatar for the corresponding target world (operation 170).

Once the final version is generated, the final version of the active avatar may be stored in the avatar wallet for future access and/or editing in preparation for a submission to another target world (operation 172).

In accordance with an aspect of the invention, the methods described above may be embodied in a computer and/or machine readable medium having executable instructions stored thereon for executing the methods.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular exemplary embodiment disclosed as the best mode contemplated for carrying out this disclosure, but that the disclosure will include all embodiments falling within the scope of the appended claims.

1. A computer readable medium having executable instructions stored thereon that cause a computer to enable a user executed method of avoiding virtual world fatigue, the method comprising:
creating a new avatar by way of an avatar editor, which is included in the computer for use in an avatar wallet, so as to generate an active avatar with an initial appearance, user information, a contact map by which real world friends of the user are mapped and characteristic sharing information;
storing the active avatar in the avatar wallet;
accessing a target world plug-in for each of a set of selected target worlds, each of the target world plug-ins including data describing allowable avatar properties of the respective target worlds, and storing each of the respective target world plug-ins in the avatar wallet so as to select target worlds, which are unique from one another, for the active avatar to visit upon a first submission thereto following the selecting operation;
subsequent to the selecting operation and prior to the first submission, modifying the initial appearance, the user information, the contact map by which the real world friends of the user are mapped and the characteristic sharing information of the active avatar by way of the avatar editor included in the computer in accordance with user preferences with respect to each of the target worlds and independent of allowable avatar properties of each of the target worlds so as to generate a version of the active avatar for respective use in corresponding ones of each of the target worlds; and
initiating the first submission with respect to a version of the active avatar to one of the corresponding target worlds such that the version is automatically tailored to the allowable avatar properties described by the stored data of the target world plug-in of the one corresponding target world, the automatic tailoring of the version comprising:
comparing the version with the allowable avatar properties described by the stored data of the target world plug-in of the one corresponding target world, and
editing the version in accordance with a result of the comparison so as to generate a final version of the active avatar for the one corresponding target world.

2-3. (canceled)

4. The method according to claim 1, wherein the modifying of the characteristic sharing information of the active avatar comprises customizing which data is allowed to be transmitted to various target worlds.

5. The method according to claim 1, further comprising storing the final version of the active avatar in the avatar wallet.
